(19) United States
(12) Patent Application Publication
(10) Pub. No.: US 2016/0351904 A1
(43) Pub. Date: Dec. 1, 2016

(54) CATHODE ADDITIVE FOR RECHARGEABLE LITHIUM BATTERIES

(71) Applicant: Board of Regents, The University of Texas System, Austin, TX (US)

(72) Inventors: John B. Goodenough, Austin, TX (US); Kyusung Park, Austin, TX (US)

(21) Appl. No.: 15/163,549

(22) Filed: May 24, 2016

Related U.S. Application Data
(60) Provisional application No. 62/167,730, filed on May 28, 2015.

(51) Int. Cl. H01M 4/58; H01M 4/525; H01M 4/36; H01M 10/0525; H01M 4/136

(52) U.S. Cl. CPC H01M 4/58; H01M 10/0525; H01M 4/136; H01M 4/366; H01M 4/5825; H01M 4/525; H01M 2004/028

(57) ABSTRACT

The present disclosure relates to a lithium nitride cathode additive for a rechargeable lithium battery, to mixtures of the additive and a cathode active material, to cathodes containing the additive, to electrochemical cells with cathodes containing the additive, and to rechargeable batteries with cathodes containing the additive.

### PRIORITY CLAIM

The present application claims priority under 35 U.S.C. §119 to U.S. Provisional Patent Application Ser. No. 62/167,730 filed May 28, 2015, which is incorporated by reference herein in its entirely.

### TECHNICAL FIELD

The disclosure relates to a cathode additive for rechargeable lithium batteries.

### BACKGROUND

### Basic Principles of Batteries and Electrochemical Cells

Batteries are divided into two principal types, primary batteries and secondary batteries. Primary batteries are used once and are then exhausted. Secondary batteries are also often called rechargeable batteries because, after use, they may be recharged, then used again. In rechargeable batteries, each charge/discharge process is called a cycle. Rechargeable batteries eventually reach an end of their usable life, but typically only after many charge/discharge cycles.

A rechargeable battery includes an electrochemical cell and optionally other materials, such as a casing to protect the cell and wires or other connectors to allow the battery to interface with the outside world. An electrochemical cell includes two electrodes, a positive electrode, called the cathode and, a negative electrode, called the anode, an insulator separating the electrodes so the battery does not short out, and an electrolyte that transports the ionic component of the chemical reaction between the two electrodes and forces the electronic component to be transported outside the cell. The anode is the reductant of the chemical reaction, the cathode the oxidant, so on discharge electrons flow from the anode to the cathode and are charge-compensated by cations flowing inside the cell from the anode to the cathode. This process transforms the chemical energy of the reaction into electric power in the external circuit by delivering a current at a voltage for a time At until the chemical reaction is completed. If the charged cell has the electric current cut off, which is called open-circuit, electrons cannot flow, but the ions inside the cell can flow without being charge-compensated. As a result, the cathode becomes positively charged on open-circuit, which is why the cathode is called the positive electrode.

The cation that is transported between the electrodes by the electrolyte is called the “working ion.” A rechargeable battery is named after the working cation. For example, the positive ion in a lithium secondary battery is the lithium ion (Li⁺). In a sodium secondary battery it is the sodium ion (Na⁺).

To recharge the battery, the same process happens in reverse by the application of electric power. By supplying electric energy to the battery, electrons are induced to leave the cathode and enter the anode. To keep the overall charge neutral in the cathode and anode, a positive ion leaves the cathode and enters the electrolyte, and a positive ion also leaves the electrolyte and enters the anode. The efficiency of electrical-energy storage in a rechargeable battery depends on the reversibility of the chemical reaction between the two electrodes.

Because the ionic conductivity in the electrolyte is many times smaller than the electronic conductivity in the electrode, a battery has large-area electrodes that are separated by a thin electrolyte. Therefore, the electrodes do not need to be thick, and, their electronic conductivity does not need to be high so long as they make contact with a metallic current collector. Consequently, in addition to containing an active material that exchanges electrons and ions, anodes and cathodes may contain other materials in addition to a metal backing to which a slurry of the active material is applied and dried. The slurry often contains, in addition to the active material, a binder to help it adhere to the backing and conductive materials, such as carbon particles. Once the slurry dries, it forms a coating on the metal backing.

Several important properties of rechargeable batteries include energy density, power density, capacity, particularly reversible capacity, rate capability, cycle life, thermal stability, cost, and safety. All of these properties are influenced by the choice of materials used to form the battery. The capacity of a battery is the amount of electronic charge that is transported at a constant current between the electrodes per unit weigh in the time At for a complete discharge, and the energy density is the product of the average voltage during discharge and the capacity. Both decrease with increasing current and, therefore, power delivered. Moreover, the cycle life of a rechargeable battery is defined as the number of charge/discharge cycles before the capacity fades to 80% of its original capacity. Capacity fade is caused by a loss of the reversibility of the chemical reaction between the electrodes.

For instance, many rechargeable lithium batteries experience a loss in reversible capacity as they are cycled because Li⁺ tend to be trapped at the surface of a strongly reducing anode and then to remain there as a passivating solid electrolyte interface (SEI) layer, making them unavailable to enter and exit the cathode and anode. Since energy density is proportional to the capacity of a battery, this loss in reversible capacity also decreases the rechargeable battery's energy density with an increasing number of cycles.

Extra lithium has previously been introduced into rechargeable batteries to attempt to reduce reversible capacity and energy density loss. In one such battery, lithium metal was deposited directly onto the anode, but this increased manufacturing costs and deteriorated the uniformity and mechanical stability of the anode, causing other problems. In another battery, Li₂NiO₂ was added to the cathode, but this material has a practical capacity of only 400 mAh/g, and this did not contribute sufficient capacity to be useful. In addition, the oxygen (O) in Li₂NiO₂ reacted significantly over time, creating other problems, and it reduced the thermal stability of the battery. In yet another battery, Li₂MoO₃ was added to the cathode, but this material has a practical capacity of only 250 mAh/g and thus was even worse at contributing charging capacity than Li₂NiO₂. In addition, the molybdenum (Mo) in Li₂MoO₃ dissolved in the electrolyte during battery use, also causing other problems.

### SUMMARY

The present disclosure relates to a lithium nitride cathode additive for a rechargeable lithium battery, to mixtures of the additive and a cathode active material, to cathodes containing the additive, to electrochemical cells with cathodes containing the additive, and to rechargeable batteries with cathodes containing the additive.

In particular, the disclosure provides a cathode including a cathode active material including lithium (Li) and a lithium nitride having the general formula LiₐQ_{b}X, wherein 2≦a≦5, 0≦b, a and b are adjusted to obtain a charged-balanced compound, X comprises N, P, or As, and Q comprises at least one of oxygen (O), fluorine (F), hydrogen (H), carbon (C), sulfur (S), chlorine (Cl), selenium (Se), bromine (Br), iodine (I), titanium (Ti), vanadium (V), chromium (Cr), manganese (Mn), iron (Fe), cobalt (Co), nickel (Ni), copper (Cu), molybdenum (Mo), tungsten (W), niobium (Nb), sodium (Na), potassium (K), magnesium (Mg), beryllium (Be), calcium (Ca), strontium (Sr), barium (Ba), scandium (Sc), yttrium (Y), aluminum (Al), gallium (Ga), zirconium (Zr), or zinc (Zn).

The disclosure also provides additional embodiments, which may be used in any combinations with one another unless clearly mutually exclusive, in which: a) the lithium nitride includes particles, further including a lithium-oxygen layer on the lithium nitride particles; b) the cathode includes 5 wt % or less lithium nitride, wherein wt % is measured by total weight of cathode active material and lithium nitride; c) the cathode includes at least 0.1 wt % lithium nitride, wherein wt % is measured by total weight of cathode active material and lithium nitride; d) the cathode active material includes a lithium metal oxide, which may include lithium cobalt oxide (LiCoO₂); e) the cathode active material includes a lithium metal phosphate, which may include lithium iron phosphate (LiFePO₄); f) the cathode may further include a current collector, a binder, a conductivity enhancer, or any combinations thereof.

The disclosure further provides an electrochemical cell including an anode, an electrolyte, and any cathode described above or elsewhere herein. In addition, in further embodiments, the lithium nitride may increase the reversible capacity of the cell by at least 50% of the theoretical capacity of the lithium nitride, the electrochemical cell may be located in a rechargeable lithium battery, or both.

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure.

FIG. 1 is an initial charging voltage curve for Li₃N.

FIG. 2 is the initial charging voltage curves for LiCoO₂ alone or with 1 wt % or 2 wt % Li₃N.

FIG. 3 is a cross-sectional, schematic diagram (not to scale) of a cathode containing a lithium nitride cathode additive.

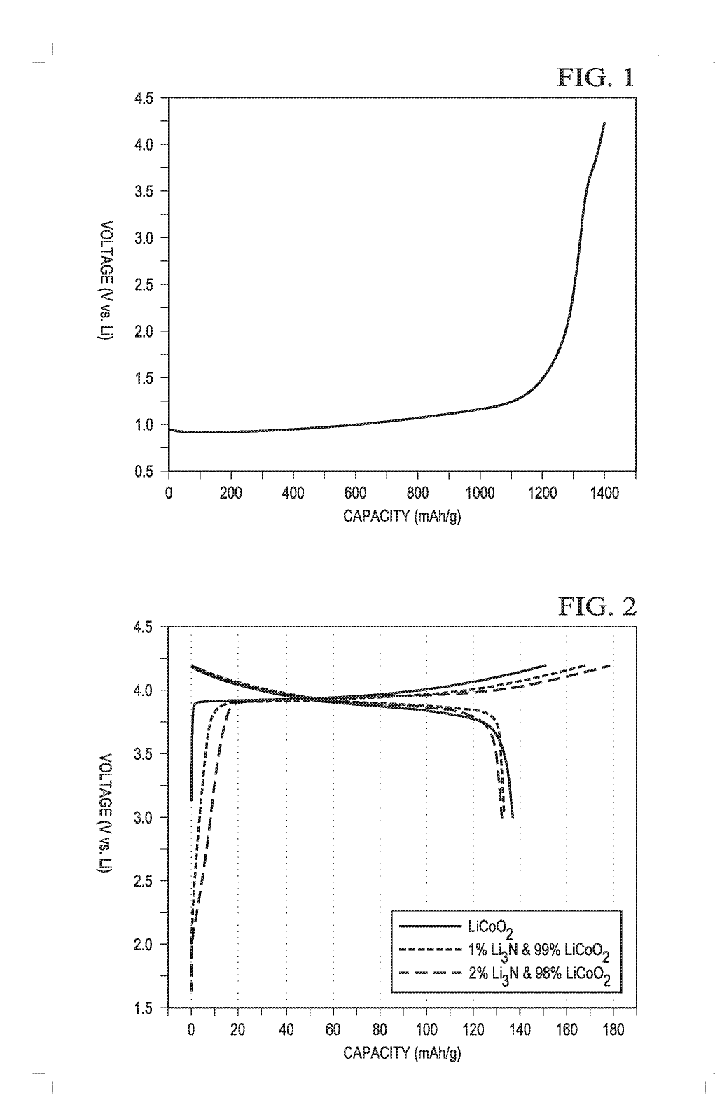

### DETAILED DESCRIPTION

The present disclosure relates to a lithium nitride cathode additive. It also includes a cathode containing this additive, an electrochemical cell containing this additive in the cathode, and a rechargeable battery containing this additive in at least on cathode. The term “nitride” as used herein refers generally to compounds containing an element from the Nitrogen Group of the periodic table (Group VB/15), also called the Pnictogen Group, and, unless specified by chemical formula, is not limited to nitrogen (N) compounds.

A lithium nitride present in the cathode can provide additional Li⁺ by electrochemical decomposition. These additional Li⁺ may replace Li⁺ originally present in the cathode active material or anode active material that are lost to SEI formation or other side reactions during cycling. This may enhance cathode utilization and delay the onset of or reduce the decrease in any one or combination of i) reversible capacity loss, ii) energy density loss, or ii) decrease in any other beneficial property due to a decrease in cyclable Li⁺ availability as compared to an otherwise identical electrochemical cell or rechargeable lithium-ion battery lacking lithium nitride. Lithium nitride may include a compound in substantially pure form or with any of a variety of dopants. Lithium nitride is represented by the general formula LiₐX, wherein X is nitrogen (N), phosphorus (P), or arsenic (As) and 2≦a≦5. Lithium nitrides specifically include Li₃N, Li₃P, and Li₃As. Lithium nitride with an optional dopant may be represented by the general formula LiaQbX, wherein Q is one or more dopant(s), 2≦a≦5, 0≦b, and a and b are adjusted to obtain a charged-balanced compound. Q may be oxygen (O), fluorine

(F), hydrogen (H), carbon (C), sulfur (S), chlorine (Cl), selenium (Se), bromine (Br), iodine (I), titanium (Ti), vanadium (V), chromium (Cr), manganese (Mn), iron (Fe), cobalt (Co), nickel (Ni), copper (Cu), molybdenum (Mo), tungsten (W), niobium (Nb), sodium (Na), potassium (K), magnesium (Mg), beryllium (Be), calcium (Ca), strontium (Sr), barium (Ba), scandium (Sc), yttrium (Y), aluminum (Al), gallium (Ga), zirconium (Zr), or zinc (Zn).

Lithium nitride may be added to any cathode or cathode active material. It may be added in any amount sufficient to obtain a certain amount of delay in the onset of or reduction in the decrease of any desirable beneficial property. The amount of lithium nitride may be limited to avoid or decrease any drawbacks, such as might occur if the cathode active material is too diluted. However, the high number of Li⁺ per molecule means that small amounts of lithium nitride, well below any amount that causes serious drawbacks, may be sufficient to obtain substantial benefits. In some instances, the amount of lithium nitride in the cathode (excluding any current collector) may be 20 wt % or less, 5 wt % or less, 2 wt % or less, 1 wt % or less, or 0.5 wt % or less. It may also be at least 0.01 wt %, at least 0.1 wt %, at least 0.5 wt %, or at least 1 wt %. It may also vary between combinations of these end points (where the amount or less is more than the at least amount).

Any cathode active material usable in a rechargeable lithium battery may benefit from the addition of lithium nitride. Generally a cathode active material in a lithium-ion battery is a chemical compound containing a transition metal, particularly a transition metal able to stably exist in more than one oxidation state, such as Ti, V, Cr, Mn, Fe, Co, Ni, Cu, Nb, and Mo. More than one transition metal may be found in the cathode active material. In addition, the cathode active material compound may contain a metal that exists stably in only one oxidation state, such as Mg, Al, or Ga. In addition to any metals, the cathode active material may contain a metalloid, such as germanium (Ge) or boron (B). The cathode active material compound also contains a nonmetal, particularly an oxygen (O)-containing nonmetal, such as an oxide, a phosphate, a sulfate, a silicate, or a vanadate. The nonmetal may also be S or a S-containing nonmetal. Example suitable cathode materials include lithium metal oxides, such as lithium cobalt oxide (LiCoO₂) and lithium manganese oxide (LiMnO₄), lithium nickel manganese cobalt oxide (LiNiMnCoO₂) lithium nickel cobalt aluminum oxide (LiNiCoAlO₂), lithium metal phosphates, such as lithium iron phosphate (LiFePO₄) lithium manganese phosphate (LiMnPO₄), and lithium iron cobalt phosphate (LiFeCoPO₄). The cathode active material may include a mixture of more than one such compound.

When added to a cathode active material, lithium nitride may provide an initial reversible capacity increase corresponding to at least 50% of the lithium nitride theoretical capacity, at least 60% of the lithium nitride theoretical capacity, at least 70% of the lithium nitride theoretical capacity, or at least 80% of the lithium nitride theoretical capacity. For instance, Li₃N has a theoretical capacity of 2308.5 mAh/g. Actual capacity is shown in FIG.

1. When added to lithium cobalt oxide (LiCoO₂) cathode active material, 1 wt % lithium nitride Li₃N increased the reversible capacity of the cathode by 18 mAh/g (Li₃N+cathode active material), corresponding to a Li₃N capacity of 1945.7 mAh/g, or 84.2% of the theoretical capacity (FIG. 2). When 2 wt % Li₃N was added to lithium cobalt oxide (LiCoO₂) cathode active material, reversible capacity increased by 28.7 mAh/g (Li₃N+cathode active material), corresponding to a Li₃N capacity of 1584.2 mAh/g, or 68.6% of the theoretical capacity (FIG. 2)

Lithium nitride may be present in the form of small particles, such as particles with a largest dimension on average of 10 μm or less, 5 μm or less, 1 μm or less, 500 nm or less, or 100 nm or less. Lithium nitride particles may be aggregated with cathode material particles or with another material in the cathode. They may also be separate, but otherwise mixed with the cathode. They may also be placed on the cathode as a separate layer.

Lithium nitride may be coated to minimize exposure to oxygen, water, or both, prior to release of Li⁺, prior to its addition to a cathode active material, or prior to its addition to a cathode. This coating may be a coating formed with the lithium nitride or later applied. For instance, it may simply be a lithium-oxygen layer formed by oxidation of the lithium nitride. Lithium nitride reacts with water, which may harm its ability to contribute Li⁺ to an electrochemical cell or rechargeable battery. In addition or as an alternative to coatings, lithium nitride may be formed, added to cathode active material, or formed into a cathode, or formed into an electrochemical cell or battery in a dry room to avoid exposure to air. Many cathode active materials are also unstable in the presence of water, allowing lithium nitride processing to be incorporated into existing cathode-related dry room procedures. Cathodes containing a lithium nitride additive may contain other materials in addition to lithium nitride and the cathode active material. For instance they may include a metal sheet or other current collector, a binder, a conductivity enhancer, such as carbon, and any combinations thereof.

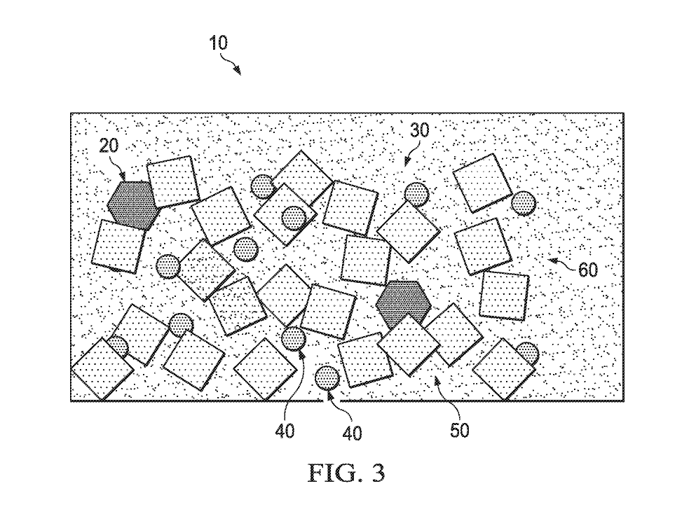

FIG. 3 is a cross-sectional, schematic diagram of a cathode 10 containing lithium nitride additive particles 20 as well as cathode active material particles 30. In this example, conductivity enhancer particles 40 are also present, along with binder 50, and the entire mixture is on a metal sheet 60.

Rechargeable lithium batteries and electrochemical cells may include lithium-ion, lithium-metal, lithium-polymer, lithium-air, and lithium-sulfur rechargeable batteries and electrochemical cells.

An electrochemical cell with a lithium nitride cathode additive may have any suitable anode. For instance, the anode may include an anode active material such as lithium metal (Li), graphite or another carbon (C), silicon (Si), a lithium metal alloy, such as a tin (Sn)/cobalt (Co) alloy, or a lithium compound, such as lithium titanate (Li₄Ti₅O₁₂). The anode may contain more than one anode active material. The anode may also contain other materials in addition to the any active material, such as a metal sheet, a binder, a conductivity enhancer, and any combinations thereof.

The electrolyte may be any electrolyte suitable for use at the voltage dictated b the cathode an anode. In order to avoid reaction of lithium nitride with water, the electrolyte may be non-aqueous. The nonaqueous electrolyte may be a liquid electrolyte, such as a nonionic liquid or an organic liquid with a lithium salt. Suitable organic liquids include carbonates, such as ethylene carbonate, propylene carbonate, diethyl carbonate, dimethyl carbonate, vinylene carbonate, and fluoroethylene carbonate, and any combinations thereof. Suitable organic liquids also include acyclic ethers such as diethyl ether, dipropyl ether, dibutyl ether, dimethoxymethane, trimethoxymethane, dimethoxyethane, diethoxyethane, 1,2-dimethoxypropane, and 1,3-dimethoxypropane, cyclic ethers such as tetrahydrofuran, tetrahydropyran, 2-methyltetrahydrofuran, 1,4-dioxane, 1,3-dioxolane, and trioxane, polyethers such as diethylene glycol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers, and sulfones such as sulfolane, 3-methyl sulfolane, 3-sulfolene, and any combinations thereof. The electrolyte may include a mixture of organic solvents. Suitable lithium salts include, LiSCN, LiBr, LiI, LiClO₄, LiAsF₆, LiCF₃SO₃, LiSO₃CH₃, LiBF₄, LiB(Ph)₄, LiPF₆, LiC(SO₂CF₃)₃, and LiN(SO₂CF₃)₂, and any combinations thereof.

Although the above electrolytes are primarily liquids, gel or solid electrolytes may also be used.

An electrochemical cell may also contain a separator to electrically insulate the cathode and anode within the cell. The cell may further contain contacts, a casing, or wiring. The cell may be in traditional form, such as a coin cell or jelly roll, or a more complex cell such as a prismatic cell.

A rechargeable battery of the present disclosure may include a single electrochemical cell or multiple cells. Batteries with more than one cell may contain components to connect or regulate these multiple electrochemical cells.

In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components.

Rechargeable batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

The details of these processes and battery components that may be formed are described above or in the following examples.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount. Additionally, one of ordinary skill in the art will appreciate that the lithium nitride compositions claimed herein could be used to supply extra lithium ions in other contexts as well, such as capacitors.

1. A cathode comprising:
a cathode active material comprising lithium (Li); and
a lithium nitride having the general formula LiₐQ_{b}X, wherein 2≦a≦5, 0≦b, a and b are adjusted to obtain a charged-balanced compound, X comprises N, P, or As, and Q comprises at least one of oxygen (O), fluorine (F), hydrogen (H), carbon (C), sulfur (S), chlorine (Cl), selenium (Se), bromine (Br), iodine (I), titanium (Ti), vanadium (V), chromium (Cr), manganese (Mn), iron (Fe), cobalt (Co), nickel (Ni), copper (Cu), molybdenum (Mo), tungsten (W), niobium (Nb), sodium (Na), potassium (K), magnesium (Mg), beryllium (Be), calcium (Ca), strontium (Sr), barium (Ba), scandium (Sc), yttrium (Y), aluminum (Al), gallium (Ga), zirconium (Zr), or zinc (Zn).

2. The cathode of claim 1, wherein the lithium nitride comprises particles, further comprising a lithium-oxygen layer on the lithium nitride particles.

3. The cathode of claim 1, comprising 5 wt % or less lithium nitride, wherein wt % is measured by total weight of cathode active material and lithium nitride.

4. The cathode of claim 1, comprising at least 0.1 wt % lithium nitride, wherein wt % is measured by total weight of cathode active material and lithium nitride.

5. The cathode of claim 1, wherein the cathode active material comprises a lithium metal oxide.

6. The cathode of claim 5, wherein the cathode active material comprises lithium cobalt oxide (LiCoO₂).

7. The cathode of claim 1, wherein the cathode active material comprises a lithium metal phosphate.

8. The cathode of claim 7, wherein the cathode active material comprises lithium iron phosphate (LiFePO₄).

9. The cathode of claim 1, wherein the cathode further comprises a current collector, a binder, a conductivity enhancer, or any combinations thereof.

10. An electrochemical cell comprising:
an anode;
an electrolyte; and
a cathode comprising:
a cathode active material comprising lithium (Li); and
a lithium nitride having the general formula LiₐQ_{b}X, wherein 2≦a≦5, 0≦b, a and b are adjusted to obtain a charged-balanced compound, X comprises N, P, or As, and Q comprises at least one of oxygen (O), fluorine (F), hydrogen (H), carbon (C), sulfur (S), chlorine (Cl), selenium (Se), bromine (Br), iodine (I), titanium (Ti), vanadium (V), chromium (Cr), manganese (Mn), iron (Fe), cobalt (Co), nickel (Ni), copper (Cu), molybdenum (Mo), tungsten (W), niobium (Nb), sodium (Na), potassium (K), magnesium (Mg), beryllium (Be), calcium (Ca), strontium (Sr), barium (Ba), scandium (Sc), yttrium (Y), aluminum (Al), gallium (Ga), zirconium (Zr), or zinc (Zn).

11. The electrochemical cell of claim 10, wherein the lithium nitride comprises particles, further comprising a lithium-oxygen layer on the lithium nitride particles.

12. The electrochemical cell of claim 10, comprising 5 wt % or less lithium nitride, wherein wt % is measured by total weight of cathode active material and lithium nitride.

13. The electrochemical cell of claim 10, comprising at least 0.1 wt % lithium nitride, wherein wt % is measured by total weight of cathode active material and lithium nitride.

14. The electrochemical cell of claim 10, wherein the cathode active material comprises a lithium metal oxide.

15. The electrochemical cell of claim 14, wherein the cathode active material comprises lithium cobalt oxide (LiCoO₂).

16. The electrochemical cell of claim 10, wherein the cathode active material comprises a lithium metal phosphate.

17. The electrochemical cell of claim 16, wherein the cathode active material comprises lithium iron phosphate (LiFePO₄).

18. The electrochemical cell of claim 10, wherein the cathode further comprises a current collector, a binder, a conductivity enhancer, or any combinations thereof.

19. The electrochemical cell of claim 10, wherein the lithium nitride increases the reversible capacity of the cell by at least 50% of the theoretical capacity of the lithium nitride.

20. The electrochemical cell of claim 10, wherein the electrochemical cell is located in a rechargeable lithium battery.
